(19) United States
(12) Patent Application Publication
(10) Pub. No.: US 2025/0281823 A1
(43) Pub. Date: Sep. 11, 2025

(54) FAST-RADIATING CLAW ASSEMBLY OF A CLAW MACHINE

(71) Applicant: FEILOLI ELECTRONIC CO., LTD., Hemei Town (TW)

(72) Inventors: Chi-Ming TSAI, Hemei Town (TW); I-Chiang YANG, Hemei Town (TW)

(21) Appl. No.: 18/601,313

(22) Filed: Mar. 11, 2024

(51) Int. Cl. A63F 9/30

(52) U.S. Cl. CPC A63F 9/30

(57) ABSTRACT

A fast-radiating claw assembly includes a cylinder, a piston movable in the cylinder, claws pivotally connected to the piston, levers for pivotally connecting the claws to the cylinder, a solenoid unit operable for moving the piston, and a metal net for covering at least a portion of a periphery of the solenoid unit. The net includes a side in contact with the cylinder and another side in contact with the solenoid unit.

### BACKGROUND OF INVENTION

### 1. Field of Invention

The present invention relates to a claw assembly of a claw machine and, more particularly, to a fast-radiating claw assembly of a claw machine.

### 2. Related Prior Art

Referring to FIG. 1, a conventional claw machine includes a conventional claw assembly equipped with a conventional solenoid unit. The conventional solenoid unit includes a cylinder or shell 10 that contains tubular core 11 that extends throughout a solenoid 12. The solenoid 12 generates magnetism when electricity goes through it. A claw assembly 13 is pivotally connected to the cylinder 10 via a linkage (not numbered) and a piston 14. The claw assembly 13 includes three claws for example. The piston 14 is movable in the tubular core 11. When electricity goes through the solenoid 12, it generates magnetism to lift the piston 14 to close the claw assembly 13. When electricity does not go through the solenoid 12, it stops magnetism to allow the piston 14 to fall to open the claw assembly 13.

As the claw assembly is in operation, the solenoid 12 generates heat as a byproduct. The temperature of the solenoid 12 inevitably rises and the electricity drops and so does the magnetism.

Various solutions have been devised for the above-mentioned problem. For example, vents can be made in the cylinder, a fan can be used to expel heat via vents made in the cylinder, or a radiating layer can be used around the solenoid. These solutions are however not satisfactory.

The present invention is therefore intended to obviate or at least alleviate the problems encountered in the prior art.

### SUMMARY OF INVENTION

It is the primary objective of the present invention to provide a fast-radiating claw assembly.

To achieve the foregoing objectives, the fast-radiating claw assembly includes a cylinder, a piston movable in the cylinder, claws pivotally connected to the piston, levers for pivotally connecting the claws to the cylinder, a solenoid unit operable for moving the piston, and a metal net for covering at least a portion of a periphery of the solenoid unit. The net includes a side in contact with the cylinder and another side in contact with the solenoid unit.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a conventional claw assembly;

FIG. 2 is an exploded view of a fast-radiating claw assembly according to the preferred embodiment of the present invention;

FIG. 3 is a perspective view of a solenoid unit of the claw assembly shown in FIG. 2;

FIG. 4 is an enlarged partial view of a net of the solenoid unit shown in FIG. 3;

FIG. 5 is a perspective view of the claw assembly shown in FIG. 2; and

FIG. 6 is a cross-sectional view of the claw assembly taken along a line VI-VI shown in FIG. 5.

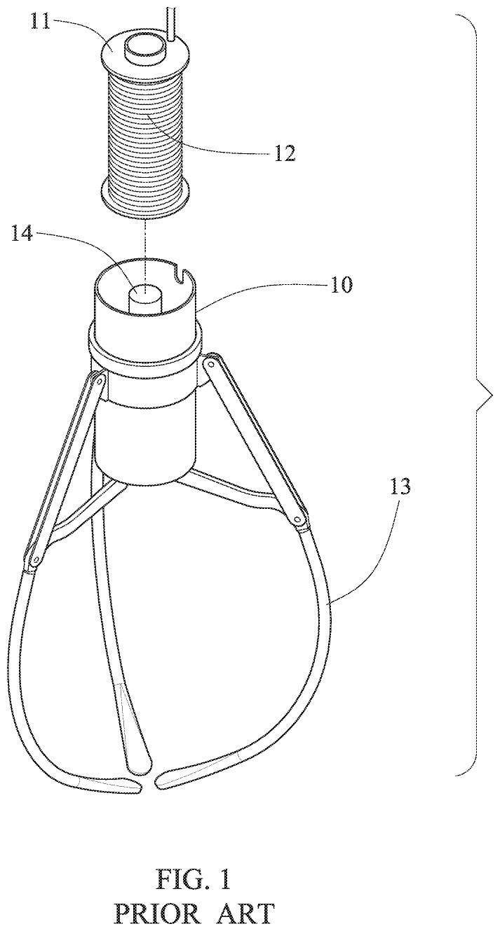

### DETAILED DESCRIPTION OF PREFERRED EMBODIMENT

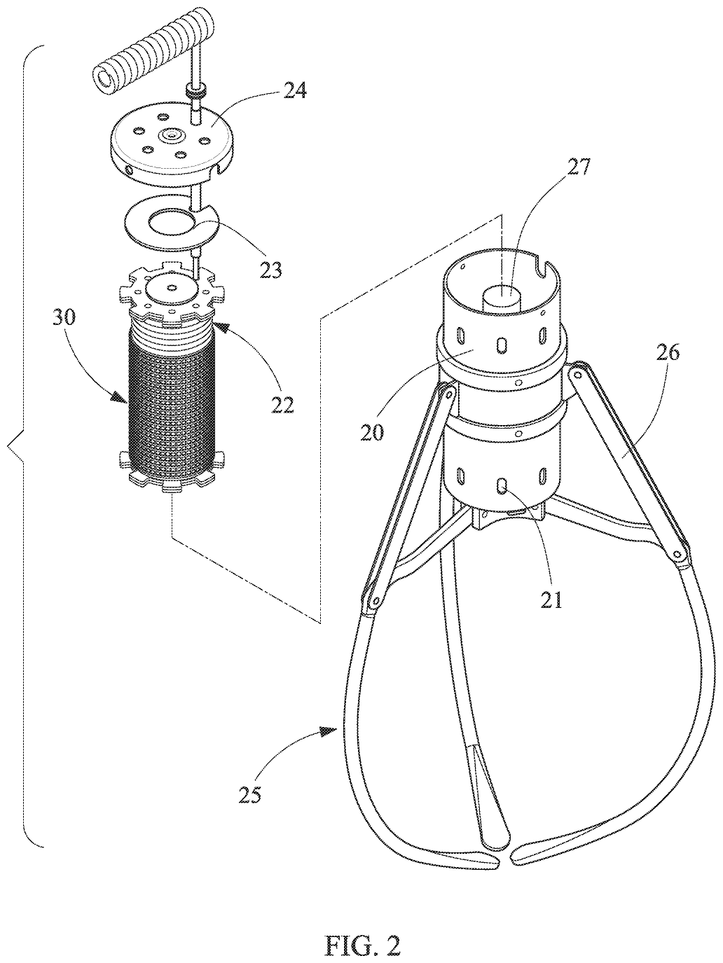

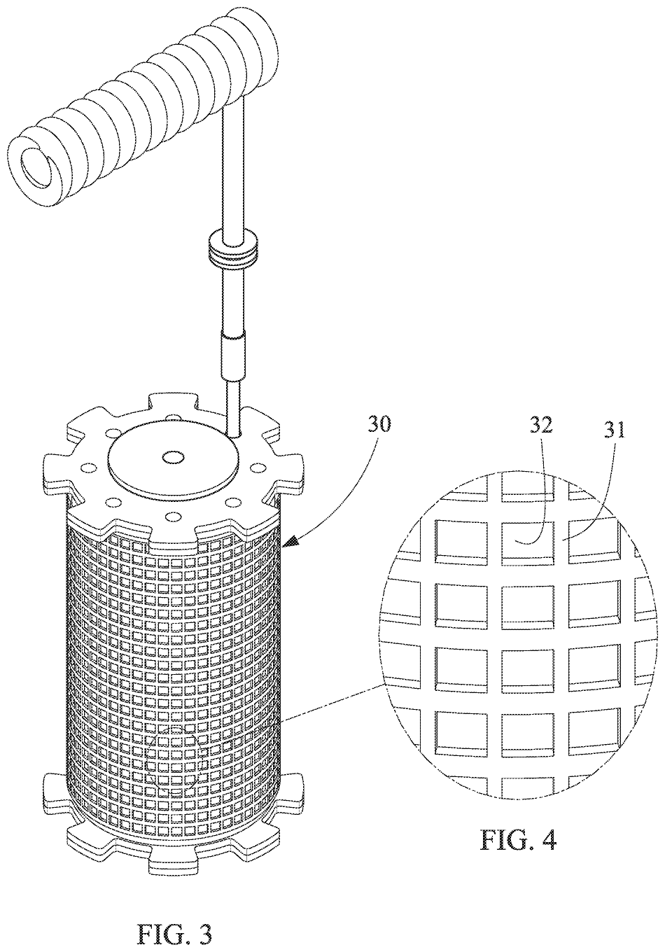

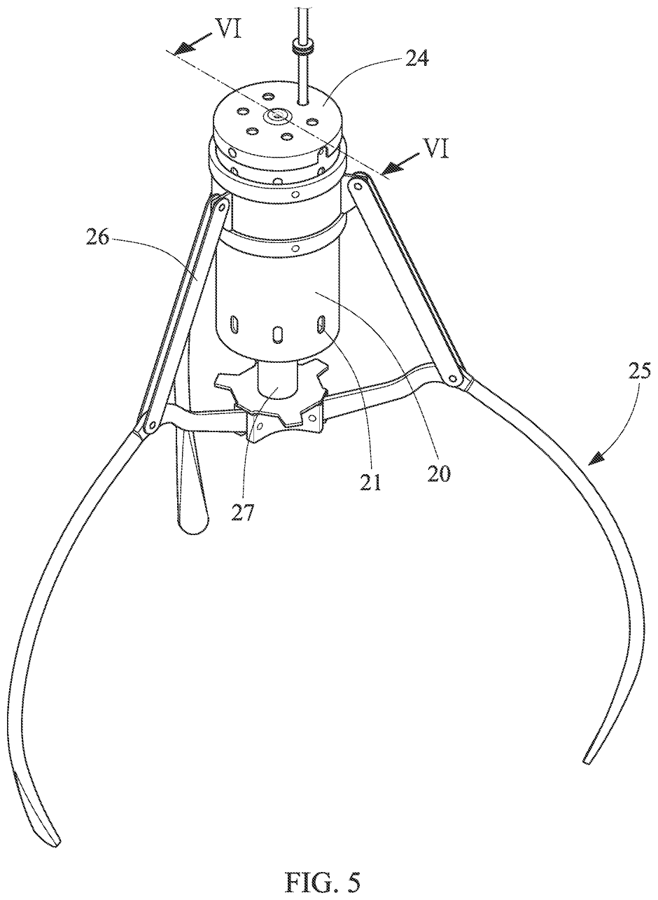

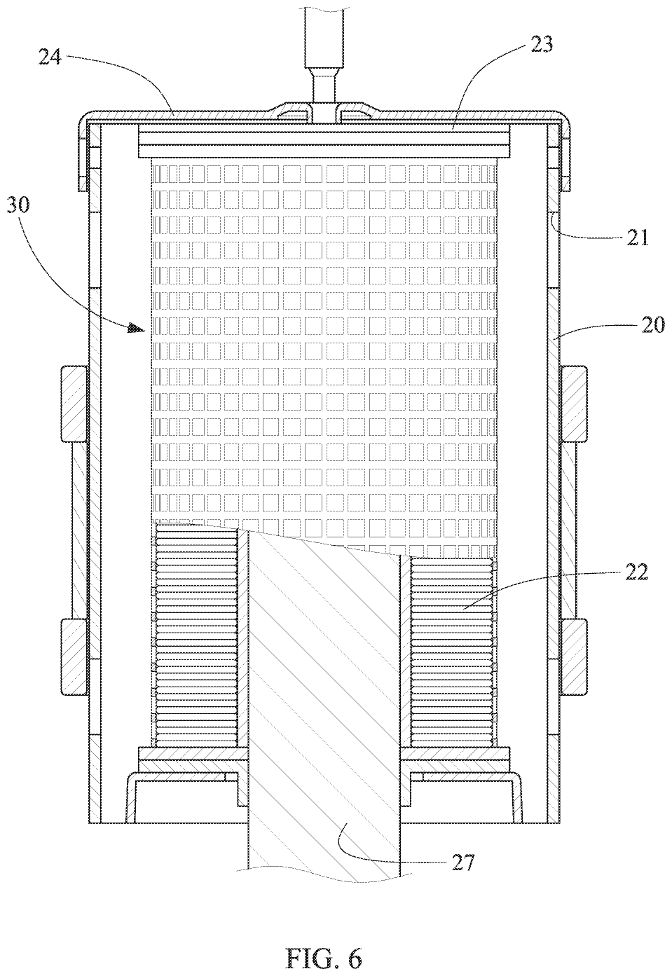

Referring to FIGS. 2 through 6, a claw machine can include a fast-radiating claw assembly that includes a cylinder 20, a solenoid unit 22, a washer 23, a lid 24, claws 25, levers 26, a piston 27 and a metal net 30 according to the preferred embodiment of the present invention. The cylinder 20 is made with vents 21 to facilitate heat to exit the cylinder 20. The claws 25 are pivotally connected to the piston 27, which is movable in the cylinder 20. Each of levers 26 includes an end pivotally connected to a corresponding one of the claws 25 and another end pivotally connected to the cylinder 20.

The solenoid unit 22 includes at least one solenoid. The solenoid unit 22 is located in the cylinder 20 so that the solenoid unit 22 extends around the piston 27. The washer 23 is located between the lid 24 and an end of the solenoid unit 22 when the lid 24 is connected to the cylinder 20.

When electricity travels through the solenoid unit 22, it generates magnetism to lift the piston 27 to close the claws 25. When electricity does not travel through the solenoid unit 22, it stops magnetism to allow the piston 27 to fall to open the claws 25.

The metal net 30 extends around the solenoid unit 22. The metal net 30 covers at least one second (50%) of the periphery of the solenoid unit 22. Preferably, the metal net 30 covers all the periphery of the solenoid unit 22. The metal net 30 metal wires 31 extend in a crisscross manner, thereby providing meshes 32. The total area of the meshes 32 in the metal net 30 is larger than the total area of the metal wires 31 in the metal net 30. The metal net 30 includes an internal side in contact with the solenoid unit 22 and an external side in contact with the cylinder 20 so that there is thermally no gap between the solenoid unit 22 and the cylinder 20. In operation, heat is transferred to the cylinder 20 from the solenoid unit 22. The heat is than radiated from the cylinder 20.

The metal net 30 is sandwiched between the solenoid unit 22 and the cylinder 20 because conduction of heat to the cylinder 20 from the solenoid unit 22 via the metal net 30 is faster than convection of heat to the cylinder 20 from the solenoid unit 22. Hence, the heat leaves the solenoid unit 22 fast so that the temperature of the solenoid unit 22 does not rise considerably so that the electricity that goes through the solenoid unit 22 does not drop considerably and nor does the magnetism. Therefore, the piston 27 is always adequately lifted and hence the claws 25 are always adequately closed.

Two metal nets 30 or more can be used around the solenoid unit 22 if so desired.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A fast-radiating claw assembly comprising a cylinder (20), a piston (27) movable in the cylinder (20), claws (25) pivotally connected to the piston (27), levers (26) for pivotally connecting the claws (25) to the cylinder (20), a solenoid unit (22) operable for moving the piston (27), and a metal net (30) for covering at least a portion of a periphery of the solenoid unit (22), wherein the net (30) comprises a side in contact with the cylinder (20) and another side in contact with the solenoid unit (22).

2. The fast-radiating claw assembly according to claim 1, wherein the metal net (30) comprises metal wires (31) extending in a crisscross manner, thereby providing meshes (32).

3. The fast-radiating claw assembly according to claim 1, wherein a total area of the meshes (32) in the metal net (30) is larger than a total area of the metal wires (31) in the metal net (30).

4. The fast-radiating claw assembly according to claim 1, wherein the metal net (30) covers at least 50% of the periphery of the solenoid unit (22).

5. The fast-radiating claw assembly according to claim 4, wherein the metal net (30) covers all the periphery of the solenoid unit (22).

6. The fast-radiating claw assembly according to claim 1, wherein the cylinder (20) comprises vents (21) for facilitating heat to exit the cylinder (20).
